(19) United States
(12) Patent Application Publication
(10) Pub. No.: US 2008/0101237 A1
(43) Pub. Date: May 1, 2008

(54) Communication device

(75) Inventors: Takao Ogura, Kawasaki (JP); Kohei Iseda, Kawasaki (JP)

Correspondence Address: BINGHAM MCCUTCHEN LLP, 2020 K Street, N.W., Intellectual Property Department, WASHINGTON, DC, 20006, US

(73) Assignee: Fujitsu Limited

(21) Appl. No.: 11/892,374

(22) Filed: Aug. 22, 2007

(30) Foreign Application Priority Data
Nov. 1, 2006 (JP) 2006-297913

(51) Int. Cl. H04L 12/24; G01R 31/08

(52) U.S. Cl. 370/235; 370/237; 370/242

(57) ABSTRACT

A communication device includes a congestion detecting part configured to detect congestion of traffic; and a message generation part configured to generate and send a MTU decreasing message, in a case where congestion is detected by the congestion detecting part and a packet having a MTU equal to or greater than a designated value is received; wherein the MTU decreasing message instructs a sender of the packet having the MTU equal to or greater than the designated value to decrease the MTU.

### BACKGROUND OF THE INVENTION

1. Field of the Invention

The present invention generally relates to communication devices, and more specifically, to a communication device forming a network.

2. Description of the Related Art

In a communication network, one frame has 1518 bytes in the conventional Ethernet (registered trademark). However, due to the appearance of the Gigabit Ethernet, recently, a device handling a jumbo frame having approximately 9,000 bytes through 16,000 bytes even in the Ethernet (registered trademark) has appeared.

It is an advantage of the jumbo frame that in a case where a large amount of data is transferred at a host server side, the number of frames to be sent is decreased so that the number of managing frames can be decreased and the CPU processing workload can be reduced.

In addition, in a router, header processing of packets can be reduced compared to a case where the MTU (Maximum Transmission Unit) is small. Therefore, the CPU processing workload can be reduced. Because of this, it is possible to achieve transferring with high throughput.

However, there are problems in the above-mentioned related art.

FIG. 1 is a first view for explaining problems of a related art network. As shown in FIG. 1, on a network formed by communication devices 1 through 5, in a case where traffic from the communication devices 1 and 3 is concentrated on the communication device 4 so that the traffic becomes congested in the communication device 4, throughput of TCP (Transmission Control Protocol) traffic of packet length having a large MTU is degraded more than that of traffic of packet length having a small MTU.

This is because, since the packet length is large, overflow from a buffer of the communication device 4 may easily occur and the rate of packet loss may be increased, so that resending by TCP flow control is implemented and the throughput of the packet flow having a large MTU is decreased.

FIG. 2 is a second view for explaining problems of a related art network.

As shown in FIG. 2, in congestion control considering packet length in a communication device 6, in a case where a packet flow having a small MTU is input from a transmission line 6a and a packet flow having a large MTU is input from a transmission line 6b, a packet having a large MTU from the transmission line 6b is lost so that the throughput of the packet flow from the transmission line 6a is improved.

Japanese Laid-Open Patent Application Publication No. 2002-051003 describes the following technique. That is to say, if reception quality of receive data is measured and receive data errors are detected, a retransmission request signal and reception quality signal are transmitted multiplexed with transmit data by a transmit frame creation section. In a transmitting side apparatus, when a retransmission request signal is received the capacity necessary for demodulating data in a receiving side apparatus is detected from a reception quality signal by a scheduling section, and data are retransmitted at that capacity.

Japanese Laid-Open Patent Application Publication No. 2005-057734 describes a network apparatus for discovering a path maximum transmission unit (MTU) in a data communication network, including: a MTU-comparer detecting a path MTU recorded in a predetermined packet transferred over a routing path between a source node and a destination node and comparing the detected path MTU with an internal MTU stored in the MTU-comparer; and an event-processor updating the path MTU recorded in the predetermined packet to contain the internal MTU if the detected path MTU is larger than the internal MTU.

While the object of the traffic of the packet length having a large MTU such as a jumbo frame is transferring with a high throughput, when the traffic is congested, the throughput of the traffic of the packet length having a large MTU is decreased compared to the traffic of the packet length having a small MTU.

### SUMMARY OF THE INVENTION

Accordingly, embodiments of the present invention may provide a novel and useful communication device solving one or more of the problems discussed above.

More specifically, the embodiments of the present invention may provide a communication device whereby degradation of throughput can be prevented even if congestion occurs.

One aspect of the present invention may be to provide a communication device, including a congestion detecting part configured to detect congestion of traffic; and a message generation part configured to generate and send a MTU decreasing message, in a case where congestion is detected by the congestion detecting part and a packet having a MTU equal to or greater than a designated value is received; wherein the MTU decreasing message instructs a sender of the packet having the MTU equal to or greater than the designated value to decrease the MTU.

According to the above-mentioned communication device of the embodiment of the present invention, degradation of throughput can be prevented even if congestion is generated.

Other objects, features, and advantages of the present invention will be come more apparent from the following detailed description when read in conjunction with the accompanying drawings.

### BRIEF DESCRIPTION OF THE DRAWINGS

FIG. 1 is a first view for explaining problems of a related art network;

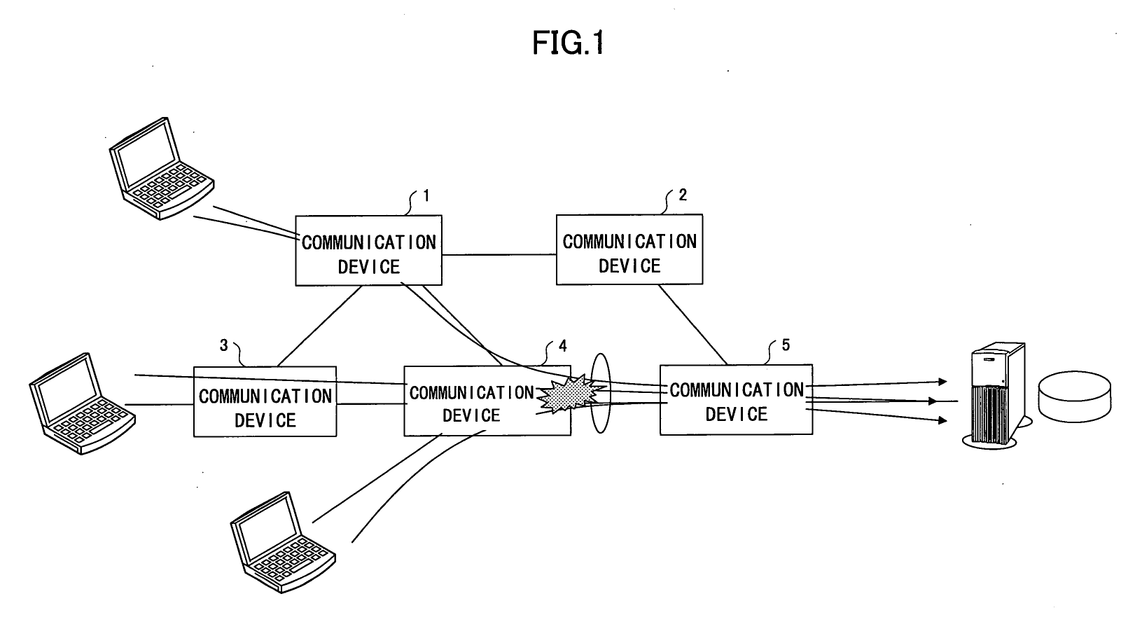

FIG. 2 is a second view for explaining problems of a related art network;

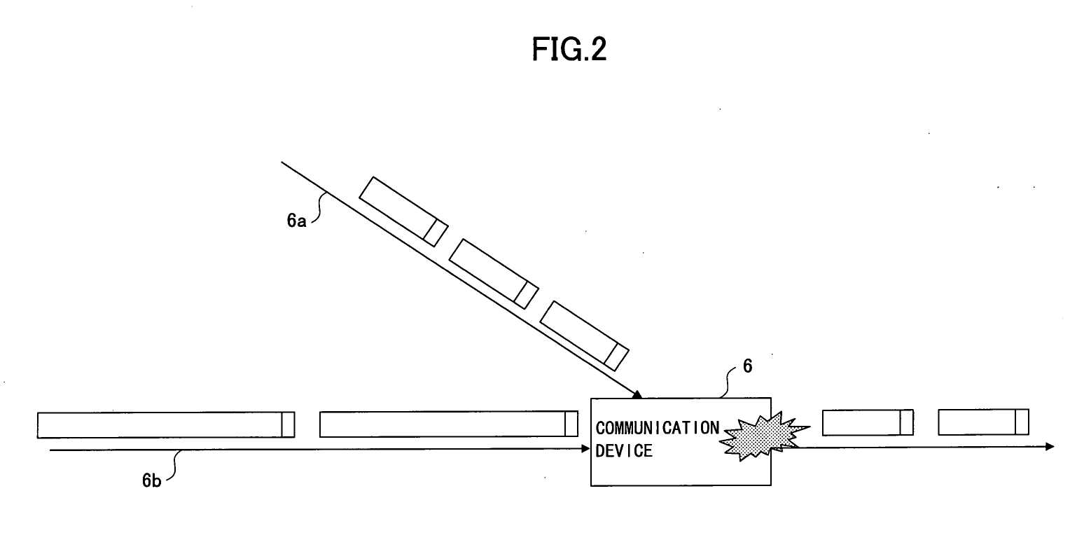

FIG. 3 is a first view showing an example of a communication network where an embodiment of the present invention is applied;

FIG. 4 is a second view showing an example of a communication network where an embodiment of the present invention is applied;

FIG. 5 is a block diagram showing an example of a communication device of the embodiment of the present invention; and

FIG. 6 is a flowchart of an MTU (Maximum Transmission Unit) changing process implemented by the communication device of the embodiment of the present invention.

### DETAILED DESCRIPTION OF THE PREFERRED EMBODIMENTS

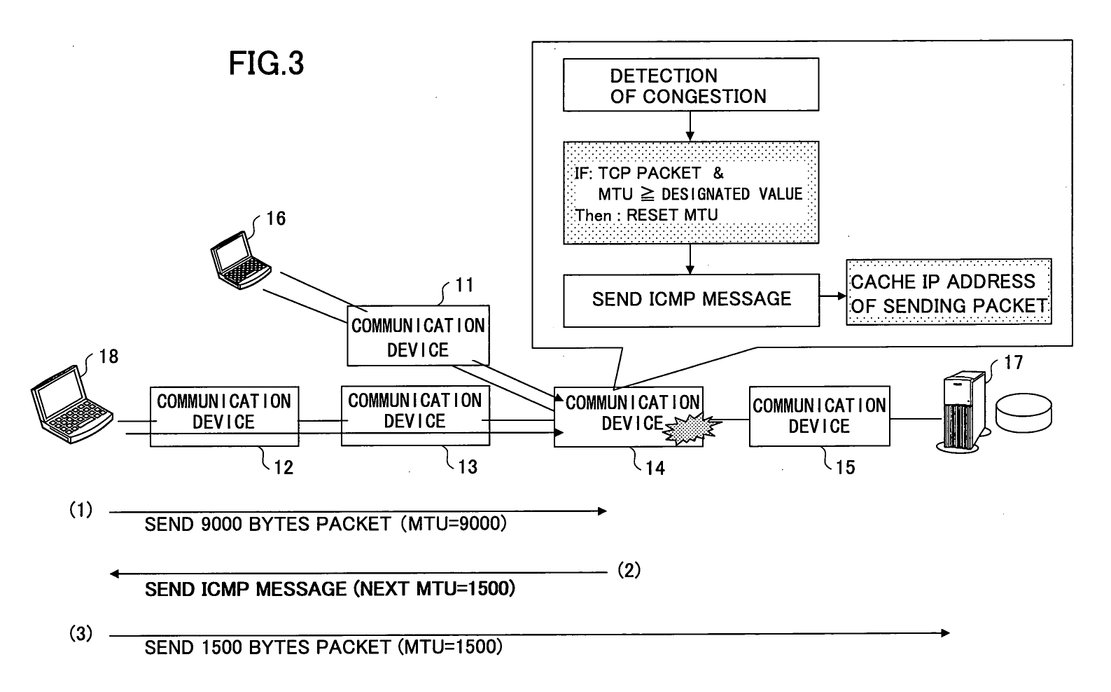

A description is given below, with reference to the FIG. 3 through FIG. 6 of embodiments of the present invention.

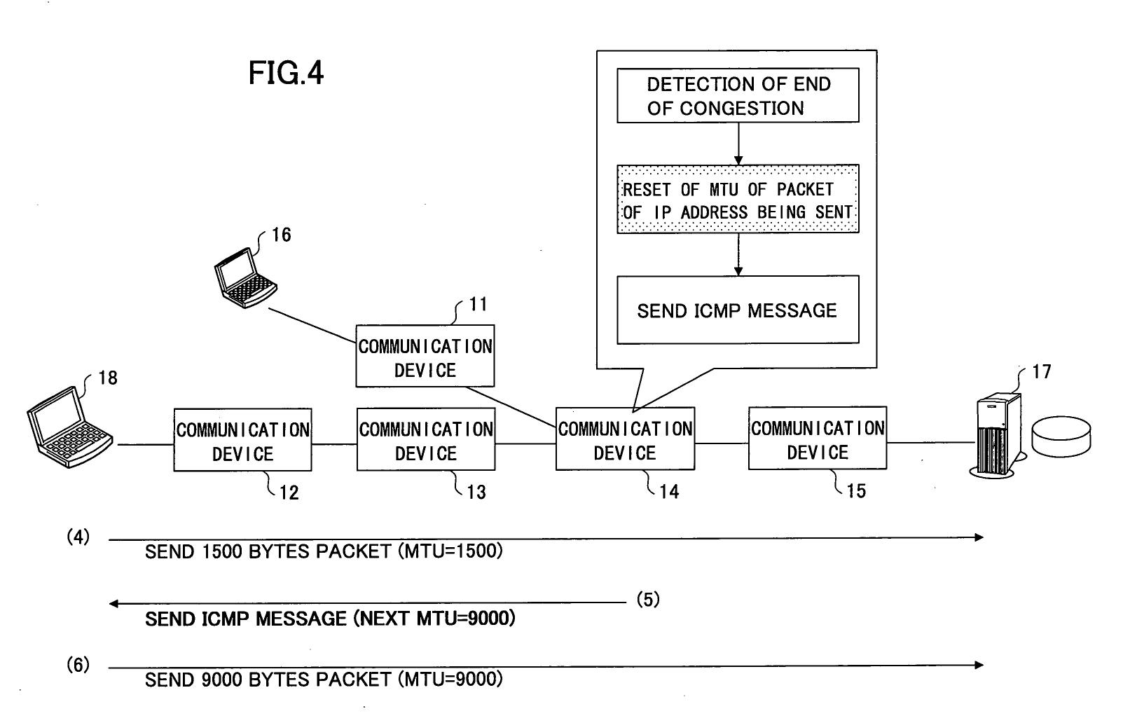

FIG. 3 is a first view showing an example of a communication network where an embodiment of the present invention is applied. FIG. 4 is a second view showing an example of a communication network where an embodiment of the present invention is applied. In FIG. 3 and FIG. 4, a numerical reference in parenthesis corresponds to a description below with the same numerical reference in parenthesis.

In FIG. 3, communication devices 11 through 15 are, for example, routers, switching hubs or the like and are connected to each other so as to form a network. A terminal 16 sends a packet whose MTU is 1,500 bytes to a server 17 via the communication devices 11, 14, and 15. A terminal 18 sends a packet whose MTU is 9,000 bytes to the server 17 via the communication devices 12, 13, 14, and 15 (1).

In a case where congestion is detected by the communication device 14, whether a packet which is a subject of resending control and whose MTU is large is received is determined. If the packet which is a TCP packet being resending-controlled and whose MTU exceeds a designated amount such as MTU=9,000 is received, the IP address of the sender of the packet is extracted and an ICMP (Internet Control Message Protocol) message is sent to the terminal 18 of the sender so that the MTU is decreased to a designated length such as 1,500 (2). In addition, the IP address for decreasing the MTU and the value of the MTU before being changed are stored in a cache memory installed in the communication device 14. Because of this, the terminal 18 decreases packet length of the packet sent to the server 17 to a designated length, namely 1,500 (3).

As a result of this, the ratio of packet loss in the communication device 14 due to the congestion of the packet transferred from the terminal 18 to the server 17 via the communication devices 12, 13, 14, and 15 is decreased so that resending by the TCP flow control is reduced and degradation of the throughput of the packets can be prevented.

FIG. 4 shows a state where, by the above-discussed control, the terminal 16 sends a packet flow whose MTU is 1,500 bytes to the server 17 via the communication devices 11, 14, and 15; and the terminal 18 sends a packet flow whose MTU is 1,500 bytes to the server 17 via the communication devices 12, 13, 14, and 15 (4).

In this state, when end of the congestion is detected by the communication device 14, since the IP address of the terminal 18 whose packet length is decreased and the value of the MTU before being changed are stored in the cache memory, an ICMP message is sent to the terminal 18 of the IP address so that the packet length is returned to 9,000 that is the value of the MTU before being changed (5). Because of this, the terminal 18 returns the packet length of the packets to be sent to the server 17 to 9,000 (6).

As a result of this, header process in each of the communication devices 12, 13, 14, and 15 of the packets transferred from the terminal 18 to the server 17 via the communication devices 12, 13, 14, and 15 is decreased so that transferring with high throughput can be realized.

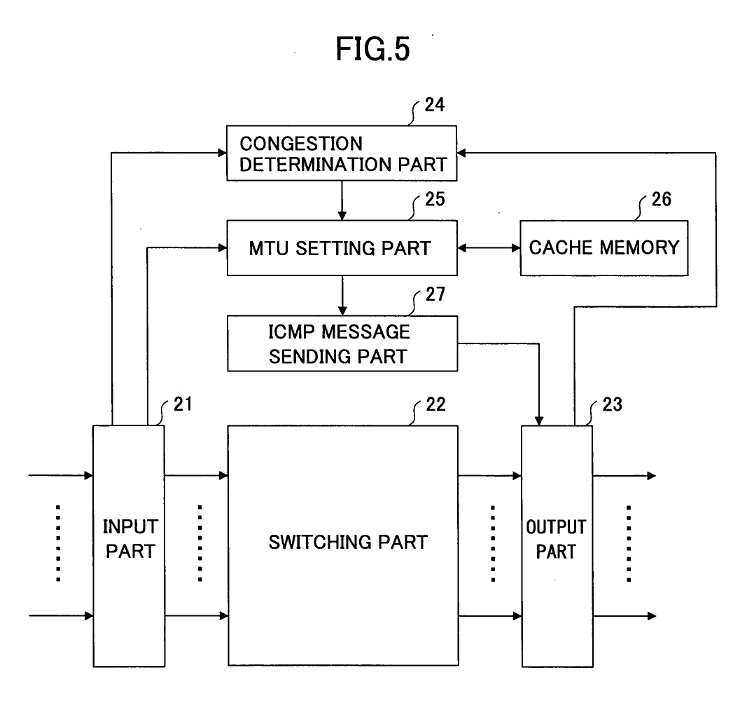

FIG. 5 is a block diagram showing an example of the communication device of the embodiment of the present invention. In the example shown in FIG. 5, an input part is connected to plural communication devices via transmission lines. A packet sent by each of the communication devices is received by the input part 21, switched by a switching part 22 and supplied to an output part 23. The output part 23 is connected to plural communication devices via transmission lines. Each of the packets switched by the switching part 22 is sent from the output part to the destination communication device.

An input buffer is provided at the input part 21 and an output buffer is provided at the output part 23. A traffic using rate and a packet loss rate at the input buffer and the output buffer are supplied to a congestion determination part 24. Here, the traffic using rate represents a present amount of transmission compared to a maximum transmission amount of each of the transmission lines. The packet loss rate represents the number of lost packets compared to the number of transmitted packets.

The congestion determination part 24 detects the congestion when the packet loss rate exceeds a threshold value A1 such as 10% or when the traffic using rate exceeds a threshold value B1 such as 80%. In addition, after the congestion is detected, if the packet loss rate becomes a threshold value A2 such as 0% or when the traffic using rate becomes a threshold value B2 such as a value less than 30%, end of the congestion is considered to have been detected. The result of detection is supplied to the MTU setting part 25. By comparing the traffic using rate to the threshold value B1, it is possible to predict generation of the congestion before the congestion is actually generated.

When the congestion is detected, the MTU setting part 25 determines whether the packet length of the input traffic is equal to or greater than a designated value, namely 9,000, and whether the input traffic whose packet length is equal to or greater than the designated value is TCP/IP traffic.

More specifically, the value of a flag (DF: Don't Fragment bit) at the IP header of the input packet indicates prevention of dividing. When the value of the protocol is TCP or IP, it is determined that there is TCP traffic.

In the case of the TCP traffic, the IP address of the sender of the packet of the TCP traffic is attached and a MTU decreasing instruction is sent to the ICMP message sending part 27. In addition, the IP address of the sender of the packet of the TCP traffic and the MTU value (MTU size) are stored in the cache memory 26.

When the end of congestion is detected, the MTU setting part 25 attaches the IP address of the sender and the MTU value (MTU size) stored in the cache memory 26 and sends the MTU increasing instruction to the ICMP message sending part 27.

When the MTU decreasing instruction is supplied, the ICMP message sending part 27 sets the IP address attached to the instruction to the IP address of destination. The ICMP message sending part 27 also generates a packet of an ICMP message whereby the packet length is decreased to the designated MTU value (MTU size), 1,500, set in advance and sends the packet from the output part 23. More specifically, 1,500 bytes are set in a NEXT MTU value (MTU size) in Code 4 (Fragmentation Needed and DF Set), Type 3 (Destination Unreachable), and an error message of the ICMP message.

When the MTU increasing instruction is supplied, the ICMP message sending part 27 sets the IP address attached to the instruction to the IP address of destination. The ICMP message sending part 27 also generates a packet of an ICMP message whereby the packet length is increased to the MTU value (MTU size) attached in the instruction, 1,500, and sends the packet from the output part 23. More specifically, 9,000 bytes are set in a NEXT MTU value (MTU size) in Code 4 (Fragmentation Needed and DF Set), Type 3 (Destination Unreachable), and an error message of the ICMP message.

In the terminal receiving the above-mentioned ICMP message, the Path MTU Discovery is operated so that the packet is sent as the MTU value (MTU size) designated by the NEXT MTU of the ICMP message.

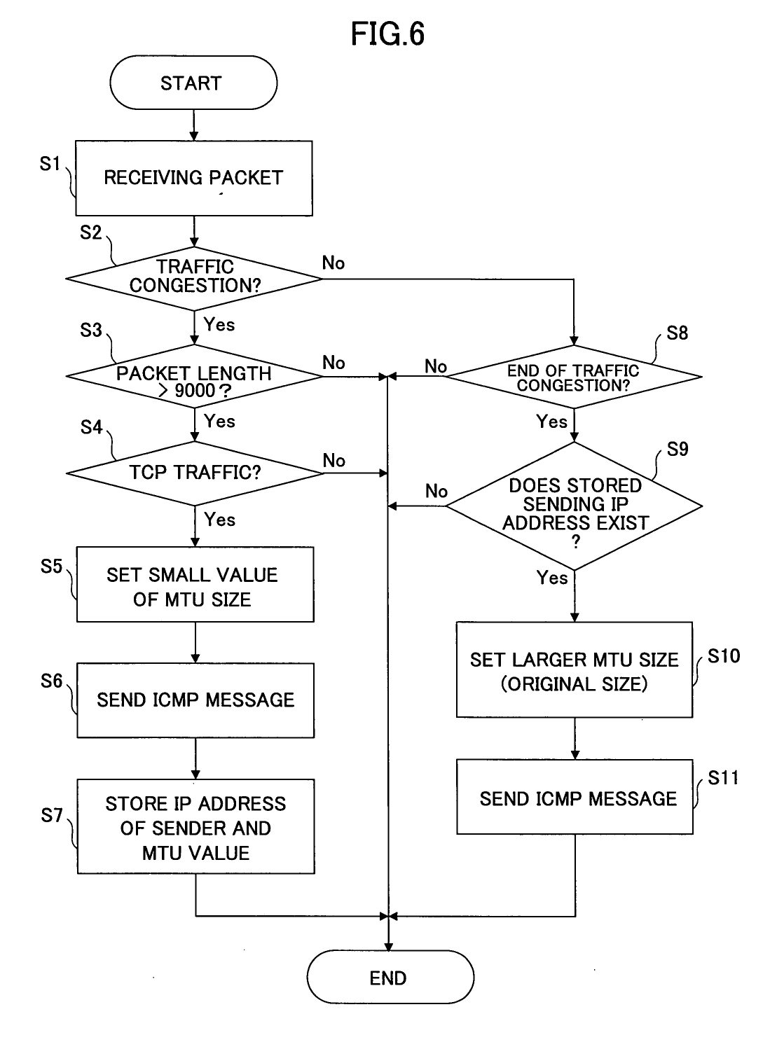

FIG. 6 is a flowchart of an MTU changing process implemented by the communication device of the embodiment of the present invention. As shown in FIG. 6, an input packet is received by the input part 21 in step S1. Next, in step S2, the congestion determination part 24 determines whether congestion of the traffic is detected.

If the congestion is detected, the process goes to step S3. The MTU setting part 25 determines whether the packet length of the input traffic is equal to or greater than 9,000. Only if the input traffic packet length is equal to or greater than 9,000, the process goes to step S4.

In step S4, whether the input traffic whose packet length is equal to or greater than the designated value, is the TCP traffic is determined. If the input traffic is the TCP traffic, the process goes to step S5.

In step S5, the designated MTU value (MTU size) such as 1,500 is set in the ICMP message by the ICMP message sending part 27. In step S6, the ICMP message is sent by using the IP address of the sender of the TCP traffic as an IP address of destination. In addition, in step S7, the IP address of the sender of the packet of the TCP traffic and the MTU value (MTU size) are stored in the cache memory 26.

On the other hand, if the congestion of the traffic is not detected in step S2, the process goes to step S8 so that whether the end of congestion of the traffic is detected is determined by the congestion determination part 24. If the end of congestion is detected, the process goes to step S9 so that whether the IP address of the sender and the MTU value (MTU size) are stored in the cache memory 26 is determined.

If the IP address of the sender and the MTU value (MTU size) are stored in the cache memory 26, the process goes to step S10, so that the MTU value (MTU size) of the cache memory 26, namely 9,000, is set in the ICMP message. In addition, in step S1, the ICMP message is sent by using the IP address of the sender of the cache memory 26 as an IP address of destination.

At the time of the end of congestion, not the ICMP message but a reset message newly set may be sent to the IP address of the sender. In this case, in a terminal or the like receiving the reset message, the MTU value (MTU size) is changed to an original MTU value (MTU size) set in advance so that the packet is sent. Therefore, it is not necessary for the communication device to store the MTU value (MTU size) prior to change in the cache memory 26.

Thus, it is possible to improve throughput transmitting efficiency by making the MTU value (MTU size) of the terminal sending a jumbo frame at the time of traffic congestion small. In addition, when the congestion is ended, the terminal sends the jumbo frame so that transmitting with high throughput can be realized.

In the meantime, the congestion determination part 24 corresponds to a congestion detecting part in claims below; the MTU setting part 25 and the ICMP message sending part 27 correspond to a message generation part in claims below; and the cache memory 26 corresponds to a storage part in claims below.

The present invention is not limited to these embodiments, but variations and modifications may be made without departing from the scope of the present invention.

This patent application is based on Japanese Priority Patent Application No. 2006-297913 filed on Nov. 1, 2006, the entire contents of which are hereby incorporated by reference.

What is claimed is:

1. A communication device, comprising:
a congestion detecting part configured to detect congestion of traffic; and
a message generation part configured to generate and send a MTU decreasing message, in a case where congestion is detected by the congestion detecting part and a packet having a MTU equal to or greater than a designated value is received;
wherein the MTU decreasing message instructs a sender of the packet having the MTU equal to or greater than the designated value to decrease the MTU.

2. The communication device as claimed in claim 1, further comprising:
a storage part configured to store an address of the sender of the packet having the MTU equal to or greater than the designated value and the MTU.

3. The communication device as claimed in claim 1,
wherein the congestion detecting part detects end of the congestion of the traffic;
the message generation part, in a case where the end of the congestion is detected by the congestion detection part and the address of the sender and the MTU are stored in the storage part, generates and sends a MTU increasing message; and
the MTU increasing message sends an instruction to the address of the sender stored in the storage part to increase the MTU to the MTU stored in the storage part.

4. The communication device as claimed in claim 1,
wherein the congestion detection part compares a packet loss rate with a threshold value so as to detect the congestion.

5. The communication device as claimed in claim 1,
wherein the congestion detection part compares a traffic using rate with a threshold value so as to detect the congestion.

6. The communication device as claimed in claim 1,
wherein the message generation part generates and sends the MTU decreasing message, in a case where the congestion is detected by the congestion detecting part; the packet having the MTU equal to or greater than the designated value is received; and the packet is a TCP/IP packet.

7. The communication device as claimed in claim 1,
wherein the MTU designated value causing the instruction to be sent to the sender by the message generation part with the MTU decreasing message is set in advance.

8. The communication device as claimed in claim 1,
wherein the congestion detecting part detects end of the congestion of the traffic;
the message generation part, in a case where the end of the congestion is detected by the congestion detection part and the address of the sender and the MTU are stored in the storage part, generates and sends a MTU reset message; and
the MTU reset message sends an instruction to the address of the sender stored in the storage part to return the MTU to the MTU set in a device of the address of the sender.

9. The communication device as claimed in claim 4,
wherein the congestion detection part detects congestion by comparing the packet loss rate to a first threshold value and detect end of the congestion by comparing the packet loss rate to a second threshold value smaller than the first threshold value.

10. The communication device as claimed in claim 1,
wherein the congestion detection part detects congestion by comparing a traffic using rate to a first threshold value and detects end of the congestion by comparing the traffic using rate to a second threshold value smaller than the first threshold value.
